(19) United States
(12) Patent Application Publication
(10) Pub. No.: US 2018/0266358 A1
(43) Pub. Date: Sep. 20, 2018

(54) COMPOSITE-PLASTIC HYBRID ENGINE COVER AND PROCESS FOR MAKING THE SAME

(71) Applicant: SABIC GLOBAL TECHNOLOGIES B.V., Bergen op Zoom (NL)

(72) Inventors: Subhransu Sekhar Mohapatra, Bangalore (IN); Arunachala Parameshwara, Bangalore (IN); Raghavendra Janiwarad, Bangalore, Karnataka (IN); Lenar Abbasov, West Bloomfield, MI (US); Fred Chang, Wixom, MI (US); Gurunath Pozhal Vengu, Bangalore (IN)

(21) Appl. No.: 15/774,700

(22) PCT Filed: Nov. 11, 2016
(86) PCT No.: PCT/IB2016/056811

§ 371 Date: May 9, 2018

(30) Foreign Application Priority Data
Nov. 11, 2015 (IN) 3685/DEL/2015

(51) Int. Cl. F02F 7/00

(52) U.S. Cl. CPC F02F 7/0073; F02F 2007/0075

(57) ABSTRACT

An engine cover is disclosed that includes a contoured laminate defining a plurality of accessory holes configured to receive a plurality of accessories. The engine cover also includes a corrugated reinforcing structure overlaid on the contoured laminate and connecting with the contoured laminate with at least one smooth transitioning angle between the contoured laminate and the corrugated reinforcing structure. The corrugated reinforcing structure defines a plurality of attachment holes. The engine cover also includes a plurality of fasteners with at least one of the plurality of fasteners being arranged in at least one of the plurality of attachment holes.

### TECHNICAL FIELD

This disclosure pertains generally, but not by way of limitation, to a nonmetallic engine cover, and more particularly, to a composite-plastic hybrid front engine accessory drive cover.

### BACKGROUND

A combustion engine is typically coupled to several engine drive accessories, such as an alternator, a power steering pump, an air conditioning compressor, an engine water pump, tensioner pulley, etc. It has been common practice in the automotive industry to mount these various engine drive accessories to a front of the combustion engine on a front engine accessory drive cover. The front engine accessory drive cover is typically configured to allow the engine drive accessories to connect with corresponding components.

Current designs of the front engine accessory drive cover are made from die-cast aluminum or aluminum-silicon alloys. Due to recent trends to reduce CO₂ emissions and improve fuel economy, the weight of the front engine accessory drive cover, in addition to other components, has become an issue. It is desirable to use thermoplastic polymeric materials in order to reduce the weight of the front engine accessory drive cover. However, there are challenges with meeting standards for material stiffness as well as requirements for chemical resistance to engine oil and other fluids, heat aging, fatigue due to engine vibrations, and the like.

Accordingly, there is a need for a front engine accessory drive cover with a lower weight compared to the traditional aluminum design while meeting performance requirements. The present disclosure aims to solve these problems and other problems in the prior art.

According to an aspect of the disclosure, an engine cover includes a contoured laminate defining a plurality of accessory holes configured to receive a plurality of accessories. The engine cover also includes a corrugated reinforcing structure overlaid on the contoured laminate and connecting with the contoured laminate with at least one smooth transitioning angle between the contoured laminate and the corrugated reinforcing structure. The corrugated reinforcing structure defines a plurality of attachment holes. The engine cover also includes a plurality of fasteners with at least one of the plurality of fasteners being arranged in at least one of the plurality of attachment holes.

According to a further aspect of the disclosure, a method of manufacturing an engine cover includes forming a contoured laminate made from a first fiber-reinforced polymer material, forming a plurality of accessory holes in the contoured laminate configured to receive a plurality of engine drive accessories, overmolding or through-molding a reinforcing structure made from a second reinforced polymer material onto at least one portion of the contoured laminate, the second reinforced polymer material being different from the first fiber-reinforced polymer material, forming a plurality of attachment holes in the reinforcing structure, the plurality of attachment holes configured to receive a plurality of fasteners.

Additional aspects of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure as recited herein.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present disclosure.

FIG. 1 illustrates a perspective view of an exterior side of a front engine accessory drive cover according to an aspect of the present disclosure.

FIG. 2 illustrates a perspective view of an interior side of the front engine accessory drive cover depicted in FIG. 1.

FIG. 3A illustrates a perspective view of a contoured laminate portion of a front engine accessory drive cover according to an aspect of the present disclosure.

FIG. 3B illustrates a perspective view of a reinforcing structure portion of a front engine accessory drive cover according to an aspect of the present disclosure.

FIG. 4 illustrates a process for manufacturing a front engine accessory drive cover according to an aspect of the present disclosure.

FIG. 5 illustrates a through-molded cross-section of a front engine accessory drive cover according to an aspect of the present disclosure.

### DETAILED DESCRIPTION

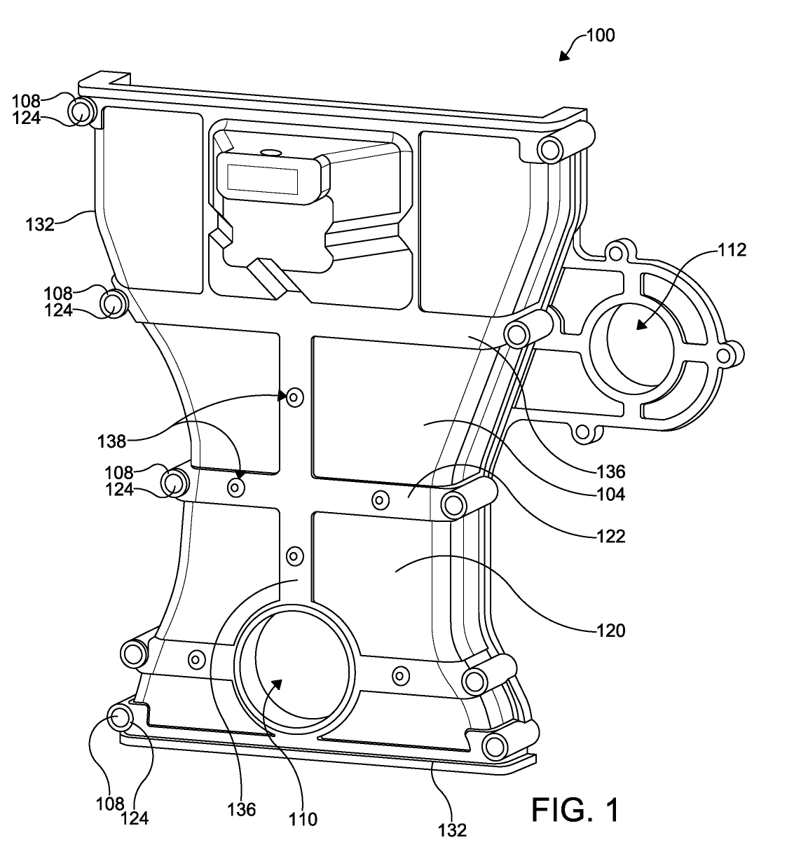

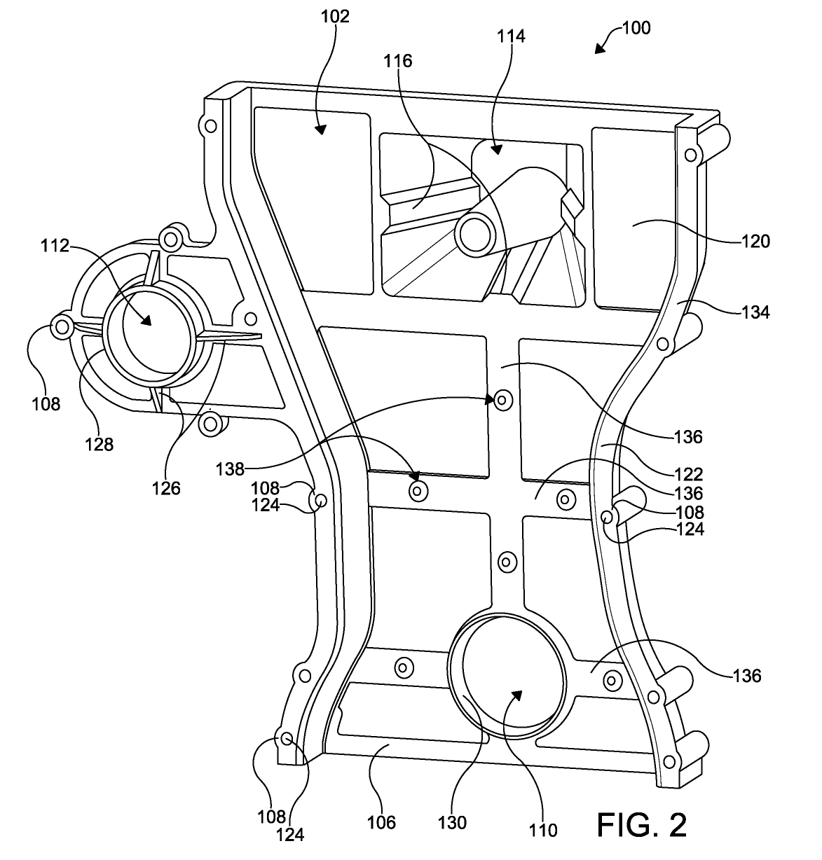

FIGS. 1 and 2 illustrate an exterior and interior perspective view, respectively, of a front engine accessory drive cover 100 according to an aspect of the present disclosure. The front engine accessory drive cover 100 includes a housing 102 having an exterior side 104 and an interior side 106. The housing 102 may be mounted to a vehicle engine (not shown). The front engine accessory drive cover 100 may be utilized with any engine, such as an internal combustion engine, a hybrid engine, and the like. Moreover, the front engine accessory drive cover 100 may also be utilized with an electric vehicle having an electric motor. For simplicity, the description will reference an engine in a non-limiting manner.

The shape and configuration of the housing 102 depends upon the engine to which the housing 102 is to be mounted and the various accessories and components required by the vehicle in general. Accordingly, if the front engine accessory drive cover 100 were to be utilized with a V6 engine, it may be designed and configured differently than if the front engine accessory drive cover 100 were to be mounted to a different engine configuration, such as an inline-triple (I3) engine. For example, a front engine accessory drive cover 100 coupled to the engine via a hanging-type mount may require additional structural support compared to other designs. Furthermore, an inline-triple engine is typically subject to higher vibrational frequencies during operation, which may require differences in structural configuration and material composition to meet performance requirements. Therefore, the design of the front engine accessory drive cover 100 and the locations of the various accessories may vary and still achieve the desired aspects of the present disclosure. It therefore should be understood that the front engine accessory drive cover 100 shown in the drawings is merely illustrative, and additional geometric modifications are contemplated in accordance with the present disclosure.

The housing 102 is configured such that the engine drive accessories or components may be attached to the exterior side 104. A predetermined number of accessories may be mounted to and/or enclosed by the housing 102. It should be understood that the location and number of engine drive accessories may be varied. The engine drive accessories may include one or more of a generator, an alternator, a water pump, a power steering pump, an air conditioning compressor, a crankshaft damper, a belt tensioner, an idler, and the like. Other components that may be mounted to the housing 102 include a vacuum pump, a fuel injection pump, an oil pump, a cam drive, and the like. These components can be incorporated with the front engine accessory drive cover 100 to form a front engine drive system. The drive accessories are mounted to the housing 102 by bolts or other mechanical fasteners known in the art at locations along the exterior side 104 and/or interior side 106 of the front engine accessory drive cover 100. In other aspects, the engine accessories may be press fit onto the front engine accessory drive cover 100.

In the non-limiting aspect illustrated by FIGS. 1 and 2, the housing 102 defines a plurality of mount holes for the engine drive accessories described above. For example, the housing 102 defines a first drive accessory mount hole 110 and a second drive accessory mount hole 112. The housing 102 also defines an engine mount cavity 114 configured to facilitate mounting of the front engine accessory drive cover 100 onto the engine (not shown). It should be appreciated that additional mount holes and cavities may be included on the housing 102 to mount numerous other drive accessories mentioned above, depending on the drive accessories needed for the corresponding engine. The features of the front engine accessory drive cover 100 shown in FIGS. 1 and 2 are provided for exemplary purposes only and are not meant to be limiting.

The front engine accessory drive cover 100 may be mounted onto the engine (not shown) via the attachment holes 108. A plurality of bolts or other mechanical fasteners known in the art may be placed through the attachment holes 108 in order to secure the front engine accessory drive cover 100 to the engine (not shown). In one aspect, a plurality of compression limiters 124 may be arranged in the attachment holes 108. The compression limiters 124 may be configured as metal inserts to provide bolt clearance so that the compression limiters 124 withstand a compressive force induced during an assembly of the mating mechanical fastener or bolt in order to secure the front engine accessory drive cover 100 in a more robust manner. If utilized, nuts or other types of mechanical fasteners may be molded into the reinforcing structure 122 as well.

The housing 102 also may have a corrugated sections 116 formed onto or in the interior side 106. The corrugated sections 116 may increase strength of the housing 102 in this particular region of the front engine accessory drive cover 100. Moreover, the corrugated sections 116 may help minimize an overall noise level transmitted via acoustics or structure to a passenger compartment of the vehicle and otherwise assist in reducing noise-vibration-harshness characteristics of the front engine accessory drive system. In the aspect shown in FIG. 2, the corrugated sections 116 are formed within the engine mount cavity 114.

Additionally, the housing 102 may include ribs formed onto or into other surfaces of the housing 102 that may need additional structural support, including on the exterior side 104 and/or interior side 106. For example, the ribs 126 may be arranged around the second drive accessory mount hole 112. The ribs 126 may increase strength of the housing 102 in this particular region of the front engine accessory drive cover 100.

Additionally or alternatively, other strengthening methods such as curved, corrugated, or faceted surfaces or other methods for minimizing noise-vibration-harshness properties may be utilized. For example, a strengthening portion 128 may be configured as a cylindrical portion that encompasses the second drive accessory mount hole 112. The strengthening portion 128 may increase strength of the housing 102 in this particular region of the front engine accessory drive cover 100.

As a further example, a strengthening portion 130 may be arranged around the first drive accessory mount hole 110. The strengthening portion 130 may increase strength of the housing 102 in this particular region of the front engine accessory drive cover 100.

The front engine accessory drive cover 100 may also include at least one edge groove 132 to provide additional support when the front engine accessory drive cover 100 is mounted to an engine (not shown) along a contact surface 134. The edge groove 132 may increase strength of the housing 102 in this particular region of the front engine accessory drive cover 100. The edge groove 132 may be formed on one or more edges of the housing 102.

Further, the front engine accessory drive cover 100 may include cross ribs 136 that span across a width, a height, and/or other direction along the housing 102. The cross ribs 136 may increase strength of the housing 102 in this particular region of the front engine accessory drive cover 100.

The design and configuration of the housing 102 provides stiffness and locates resonant frequencies of the assembled system in the least objectionable places. These features can be accomplished through system design rather than individual component design.

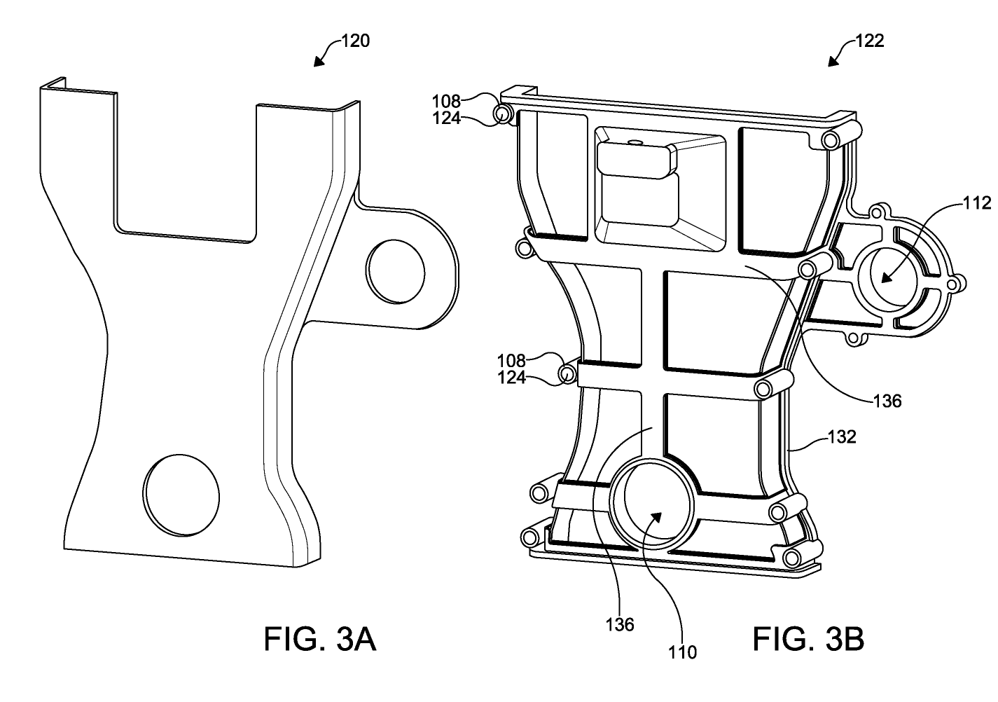

In one aspect, the front engine accessory drive cover 100 includes a contoured laminate 120 and a reinforcing structure 122. The contoured laminate 120 may have a contoured geometry configured for use as a housing cover. The contoured laminate may be curved or contoured along the width and/or length and may have various cross-sections suitable for use as a housing cover. In the aspect shown in FIGS. 1 and 2, the contoured laminate 120 has a generally U-shaped cross-section. The material composition of the contoured laminate 120 and reinforcing structure 122 will be described in further detail with reference to FIGS. 3A and 3B. The contoured laminate 120 and reinforcing structure 122 together form the housing 102 of the front engine accessory drive cover 100. The reinforcing structure 122 may be overlaid on the contoured laminate 120 with at least one smooth transitioning angle between the contoured laminate 120 and the reinforcing structure 122. As illustrated in FIGS. 1 and 2, some regions of the housing 102 may be composed by an overlap between the contoured laminate 120 and the reinforcing structure 122 while other regions may be composed of only the contoured laminate 120 or the reinforcing structure 122.

FIG. 3A illustrates the contoured laminate 120 for use in the front engine accessory drive cover 100. The first fiber-reinforced polymer material includes a first thermoplastic resin. The contoured laminate 120 may be made from a first fiber-reinforced polymer material. The first fiber-reinforced polymer material may include a laminate made from at least one of a uni-directional tape, a woven fabric, and a non-woven fabric. The laminate may be made through a melt process, from a chemical solution, from a powder, or by film impregnation. The woven and non-woven fabric materials may be made from the first thermoplastic resin. Specific non-limiting examples of suitable thermoplastic resins include polyacetal, polyacrylic, styrene acrylonitrile, acrylonitrile-butadiene-styrene (ABS), polycarbonate, polystyrene, polyethylene, polyphenylene ether, polypropylene, polyethylene terephthalate, polybutylene terephthalate, Nylons (Nylon-6, Nylon-6/6, Nylon-6/10, Nylon-6/12, Nylon-11 or Nylon-12, for example), polyamideimide, polyarylate, polyurethane, ethylene propylene diene rubber (EPR), ethylene propylene diene monomer (EPDM), polyarylsulfone, polyethersulfone, polyphenylene sulfide, polyvinyl chloride, polysulfone, polyetherimide, polytetrafluoroethylene, fluorinated ethylene propylene, perfluoroalkoxyethylene, polychlorotrifluoroethylene, polyvinylidene fluoride, polyvinyl fluoride, polyetherketone, polyether ether ketone (PEEK), liquid crystal polymers and mixtures comprising any one of the foregoing thermoplastics. The thermoplastic resin may also be propriety resin materials, such as Noryl GTX™, which is a blend of polyamide and modified polyphenylene ether, or Thermocomp RC008™, which is a Nylon 66 resin. It is anticipated that any thermoplastic resin may be used in the present disclosure that is capable of being sufficiently softened by heat to permit fusing and/or molding without being chemically or thermally decomposed. In one aspect, the first thermoplastic resin is a blend of polyamide and modified polyphenylene ether polymer.

The first fiber-reinforced polymer material of the contoured laminate 120 may also include at least one type of continuous fiber material designed to help provide strength to the contoured laminate 120. Fibers suitable for use in the disclosure include glass fibers, carbon fibers, graphite fibers, synthetic organic fibers, particularly high modulus organic fibers such as para- and meta-aramid fibers, nylon fibers, polyester fibers, or any of the thermoplastic resins mentioned above that are suitable for use as fibers, natural fibers such as hemp, sisal, jute, flax, coir, kenaf and cellulosic fibers, mineral fibers such as basalt, mineral wool (e.g., rock or slag wool), Wollastonite, alumina silica, and the like, or mixtures thereof, metal fibers, metalized natural and/or synthetic fibers, ceramic fibers, or mixtures thereof. In one aspect, the fibers selected for the first fiber-reinforced polymer material of the contoured laminate 120 are continuous carbon-fibers.

The fibers selected for the first laminate-composite material may be continuous filaments embedded in the thermoplastic resin. During manufacturing, the fibers are typically formed into sheets and impregnated with the thermoplastic resin to form the composite-laminate material. The fiber content in the contoured laminate 120 may be between 10% to 50%, for example. The fiber content may be within the range of 10% to 20%, 20% to 30%, 30% to 40%, or 40% to 50% by weight, based upon the total weight of the contoured laminate. In one aspect, the first fiber-reinforced polymer material is a continuous carbon-fiber impregnated with a blend of polyamide and modified polyphenylene ether polymer.

FIG. 3B illustrates the reinforcing structure 122 for use in the front engine accessory drive cover 100. The reinforcing structure 122 may be made from a second reinforced polymer material. In some aspects, the second reinforced polymer material may be the same as the first fiber-reinforced polymer materials. In other aspects, the second reinforced polymer material may be different from the first fiber-reinforced polymer material. The second reinforced polymer material may be a chopped-fiber reinforced polymer while the first fiber-reinforced polymer material is a continuous-fiber reinforced polymer. Because the chopped fibers may have random orientations compared to continuous fibers, the finished composite-laminate material may have improved in-plane stiffness, bending stiffness, strength, and other structural properties. The second reinforced polymer material may be selected for portions of the front engine accessory drive cover 100 that may need additional support, such as the strengthening portion 128, the strengthening portion 130, the edge groove 132, the contact surface 134, the cross ribs 136, and the like.

The second reinforced polymer material for the reinforcing structure 122 also may include a second thermoplastic resin. The second thermoplastic resin may be selected from the non-exhaustive list of first thermoplastic resins described above with respect to the contoured laminate 120. Although the second thermoplastic resin of the reinforcing structure 122 may be different than the first thermoplastic resin selected for the contoured laminate 120, it may be desirable that the first thermoplastic resin and the second thermoplastic resin share a common polymeric material. For example, in one aspect, the first thermoplastic resin is a blend of polyamide and modified polyphenylene ether polymer while the second thermoplastic resin is polyamide. Thus, the first thermoplastic resin and the second thermoplastic resin may have the polymer polyamide in common. The shared polymer allows for improved chemical bonding between the contoured laminate 120 and the reinforcing structure 122 during the manufacturing process of the front engine accessory drive cover 100. The specific materials mentioned above are merely described for exemplary purposes. Additional combinations of thermoplastic resins may be selected for the contoured laminate 120 and/or the reinforcing structure 122 to meet desired material properties for the specific geometry of the front engine accessory drive cover 100.

As mentioned above, the second reinforced polymer material for the reinforcing structure 122 may include chopped polymeric fibers, fillers or flakes. The chopped polymeric fibers may be short-chopped fibers or long-chopped fibers. Generally, short-chopped fibers may have an average length of 2 millimeter (mm) or less, such as 1 mm. In contrast, long-chopped fibers may have an average length of 2 mm or more. For example, in some aspects, the long-chopped fibers may have an average length of 5 mm or greater, or 10 mm or greater. Suitable materials for the chopped-fiber may be selected from the non-exhaustive list of fiber materials described above with respect to the contoured laminate 120. In one aspect, the fibers for the reinforcing structure 122 are short-chopped carbon fibers.

In addition to carbon fibers as described above, the compositions of the second reinforced polymer material for the contoured laminate 120 and/or reinforcing structure 122 may include additional fillers. Non-limiting examples of other fillers which may be included are glass fibers, mica, talc, clay, silica and Wollastonite. Minor amounts of other materials may also be included to modify specific properties of the composition. For example, polytetrafluoroethylene (PTFE) in amounts of up to about 1% may be included as part of a flame retardant package. Other types of flame retardant packages including brominated flame retardant polymers (e.g., brominated PC) or phosphorus-containing organic flame retardants (such as resorcinol diphosphate, bisphenol A diphosphate or tetraxylyl piperazine diphosphamide) may also be included in effective amounts up to about 30%. PTFE may also be included in larger amounts, up to about 25%, to improve wear resistance; and polyethylene may be included in amounts up to about 2% to improve mold release characteristics. Impact modifiers such as styrene-butadiene-styrene (SBS) may be included in amounts up to about 10% to improve impact strength. Flow promoters such as hydrogenated polyterpene may also be included in amounts up to about 15%.

The second reinforced polymer material for the contoured laminate 120 and/or reinforcing structure 122 may also include a conductive filler. Suitable conductive fillers include solid conductive metallic fillers or inorganic fillers coated with a solid metallic filler. These solid conductive metal fillers may be an electrically conductive metal or alloy that does not melt under conditions used when incorporating them into the polymeric resin, and fabricating finished articles therefrom. Metals such as aluminum, copper, magnesium, chromium, tin, nickel, silver, iron, titanium, and mixtures including any one of the foregoing metals may be incorporated into the thermoplastic resin as solid metal particles. Physical mixtures and true alloys such as stainless steels, bronzes, and the like, can also serve as metallic constituents of the conductive filler particles herein. In addition, a few intermetallic chemical compounds such as borides, carbides, and the like, of these metals (e.g., titanium diboride) may also serve as metallic constituents of the conductive filler particles herein.

Table 1 below shows a comparison between performances of the front engine accessory drive cover 100 constructed consistent with the disclosure and a conventional front engine accessory drive cover. The conventional front engine accessory drive cover was made from aluminum and the front engine accessory drive cover 100 was made from a composite-plastic material. The natural frequencies of different modes were tested for both designs at an operating temperature of 100° C. The front engine accessory drive cover 100 had less mass compared to the aluminum front engine accessory drive cover. In one aspect, the front engine accessory drive cover 100 had a reduction of 15% mass compared to the aluminum front engine accessory drive cover. Similar mass reduction may be expected for other geometries. Moreover, the composite-plastic design showed comparable frequency values.

TABLE 1
Comparison of Performance

| | Frequency (Hz) | | |
|---|---|---|---|
| | | Composite- | Performance |
| Frequency Mode | Aluminum | Plastic | Comparison (%) |
| Water Pump | 347 | 360 | 4 |
| Engine Mount + | 1586 | 1550 | −2 |
| Accessory Pulley | | | |
| Accessory Pulley | 1856 | 1857 | 0 |
| Engine Mount | 2383 | 2250 | −6 |
| Regulatory | 1186 | 1998 | −9 |
| Magnet Covers | | | |

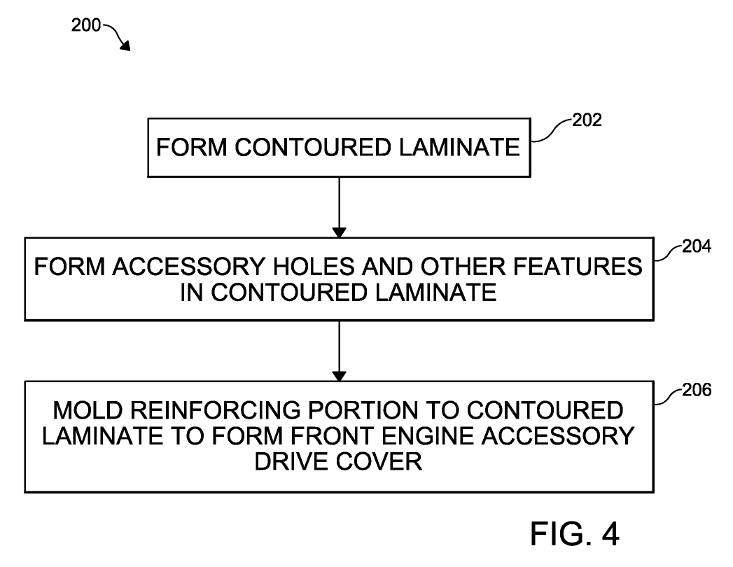

FIG. 4 illustrates a process 200 for manufacturing a front engine accessory drive cover 100 according to an aspect of the present disclosure. At step 202, the contoured laminate 120 of the front engine accessory drive cover 100 may be formed. In this regard, the contoured laminate 120 may be cut prior to molding to form the desired shape including the first drive accessory mount hole 110, the second drive accessory mount hole 112, the engine mount cavity 114, and the like. The laminate may be further formed as a single component through a molding process. The molding process may be used to form the desired shape and other features of the contoured laminate 120 of the front engine accessory drive cover 100, such as first drive accessory mount hole 110, the second drive accessory mount hole 112, the engine mount cavity 114, and the like, as well as the contours, corrugations, and overall shape of the contoured laminate 120. Alternatively, in step 204, one or more of the mount holes and other features may be formed after the molding process.

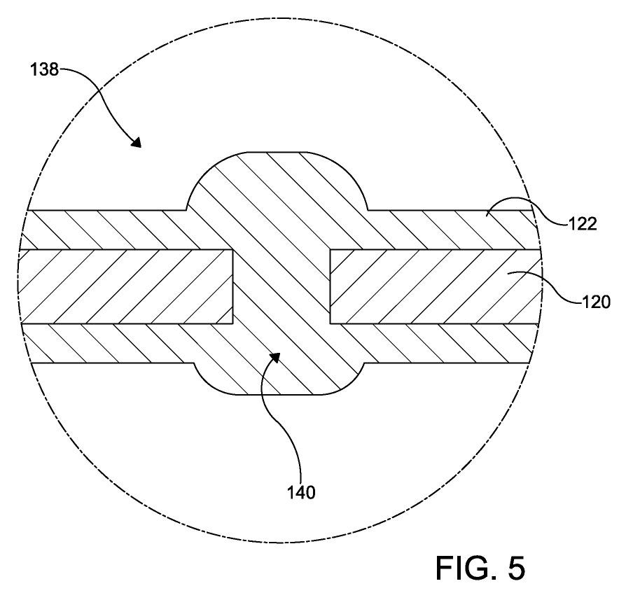

In step 206, after the contoured laminate 120 is formed, the second reinforced polymer material for the reinforcing structure 122 may be injected onto the contoured laminate 120 and overmolded or through-molded to form the front engine accessory drive cover 100. FIG. 5 illustrates an example of through-molding at a cross-section of the front engine accessory drive cover 100 at a button location 138 shown in FIGS. 1 and 2. The reinforcing structure 122 may flow through an injection hole 140 formed into the contoured laminate 120. Once the front engine accessory drive cover 100 is cooled, the through-molding of the reinforcing structure 122 may provide improved bonding of the reinforcing structure 122 onto the contoured laminate 120 compared to overmolding. The front engine accessory drive cover 100 may have a plurality of button locations 138 where the reinforcing structure 122 is through-molded on the contoured laminate 120.

The reinforcing structure 122 may be formed such that the reinforcing structure is overlaid on the contoured laminate 120 with at least one smooth transitioning angle between the reinforcing structure 122 and the contoured laminate 120. Step 206 may further include forming the strengthening portion 128, the strengthening portion 130, the edge groove 132, the contact surface 134, the cross ribs 136, and the like. Moreover, step 206 may further include arranging the plurality of compression limiters 124 at desired locations for the attachment holes 108. If utilized, nuts or other types of mechanical fasteners may be molded into the reinforcing structure 122 as well.

A front engine accessory drive cover 100 constructed consistent with the present disclosure may reduce weight by around 15% compared to a metal design. Further, a front engine accessory drive cover 100 may have the following properties (1) high stiffness, (2) high temperature performance, (3) chemical resistance, (4) improved fatigue properties, and (5) improved creep properties.

High stiffness of the front engine accessory drive cover 100 is achieved through a combination of material and geometry as described above. Thermoplastic materials described in the present disclosure may have a high Young's Modulus, which may be almost 40 to 50% of that of aluminum. Additional stiffness may be achieved through strategic placing of the corrugated sections 116, the ribs 126, the strengthening portion 128, the strengthening portion 130, the edge groove 132, and the cross ribs 136.

High temperature performance of the front engine accessory drive cover 100 may be achieved through placing of continuous carbon laminates at strategic locations such as overhanging portions and the main body of the housing 102. This may include unattached areas around magnet covers, accessory pulleys, and other drive accessories. In some aspects, this may not include areas which have higher depth such as the engine mount. The areas with higher depth may be stiffened instead with an optimized rib structure since the depth gives package space to place rib structures, such as the ribs 126.

Chemical resistance may be achieved through the selection of materials as described above. This may include materials such as NORYL™ GTX and RC008, which have excellent chemical resistance compared to other materials known in the art.

Improved fatigue properties may be achieved through the use of composite-laminate materials. The disclosed composite-laminate materials may have better fatigue properties than metal since they have inherent voids which do not allow cracks to propagate.

Improved creep properties may be achieved through various features of the present disclosure. For example, creep at load bearing attachment areas may be prevented through metal nuts or compression limiters 124, which may be insert molded into, placed through, or otherwise attached to the front engine accessory drive cover 100.

A front engine accessory drive cover 100 constructed consistent with the present disclosure exhibits frequencies in the same range as incumbent metal designs. For example, a front engine accessory drive cover 100 may be within ±10% of the performance of metal designs at high temperatures, such as 100° C.

To achieve such performance, at least four different types of mounts may be used to couple the various drive accessories to the front engine accessory drive cover 100. The first type may be a hard mount where all translational and rotational motion is constrained. The first type may be used to mount the front engine accessory drive cover 100 to the engine block. The second type may be a soft mount used at the locations where the front engine accessory drive cover 100 is joined to other major engine structures, such as an oil pan, a cylinder head, or the like. The third type may be a hanging accessory mount. The third type may be used for attachment of various drive accessories, such as the water pump, to the front engine accessory drive cover 100. There may be little or no stiffness contribution and some lumped mass contribution from the drive accessories to the mount. The fourth type may be a pure sealing attachment. The fourth type may be used for attachment of the front engine accessory drive cover 100 to minor non-structural parts, such as regulatory magnet covers. There may be little or no constraints to translational and rotational motion or lumped mass contribution from the minor non-structural parts.

Although the present disclosure has been described with respect to a front engine accessory drive cover, it should be understood that the design considerations for material composition and structural configuration may be applicable for coverings of other components in a vehicle or machine, such as a powertrain component housing, a drivetrain component housing, a clutch housing, a rear axle housing, a final drive housing, a differential housing, an automatic transmission housing, a torque converter housing, a transmission housing, a transaxle housing, a drive shaft housing, a transfer box housing, a gearbox housing, and the like. Similar to the front engine accessory drive cover, these other housings in a vehicle or machine may benefit from being formed from thermoplastic materials compared to metal to reduce weight. These housings may be formed from the thermoplastic materials described above according to the process 200 described above. These coverings may also include similar structural features placed in strategic locations such as the corrugated sections 116, the ribs 126, the strengthening portion 128, the strengthening portion 130, the edge groove 132, and the cross ribs 136. Finally, these housings may further include accessory holes configured to receive accessories associated with one or more of a powertrain component, a drivetrain component, a clutch, a rear axle, a final drive, a differential, an automatic transmission, a torque converter, a transmission, a transaxle, a drive shaft, a transfer box, a gear box, and the like.

It will be appreciated that the present disclosure may include any one and up to all of the following examples.

### Example 1

An engine cover comprises a contoured laminate defining a plurality of accessory holes configured to receive a plurality of accessories, a corrugated reinforcing structure overlaid on the contoured laminate and connecting with the contoured laminate with at least one smooth transitioning angle between the contoured laminate and the corrugated reinforcing structure, the corrugated reinforcing structure defining a plurality of attachment holes, and a plurality of fasteners, at least one of the plurality of fasteners being arranged in at least one of the plurality of attachment holes.

### Example 2

The engine cover of Example 1, wherein the contoured laminate is made from a first fiber-reinforced polymer material, and the corrugated reinforcing structure is made from a second reinforced polymer material different from the first fiber-reinforced polymer material, and the corrugated reinforcing structure is overmolded or through-molded onto a first portion of the contoured laminate.

### Example 3

The engine cover of Example 2, wherein the first fiber-reinforced polymer material comprises a first thermoplastic resin.

### Example 4

The engine cover of any one of Examples 2-3, wherein the second reinforced polymer material comprises a second thermoplastic resin that is the same or different from the first thermoplastic resin.

### Example 5

The engine cover of Example 4, wherein the second thermoplastic resin is polyamide.

### Example 6

The engine cover of any one of Examples 3-5, wherein the first thermoplastic resin comprises polyamide and the second thermoplastic resin comprises polyamide.

### Example 7

The engine cover of any one of Examples 3-6, wherein the first thermoplastic resin is a combination of polyamide and polyphenylene ether polymer.

### Example 8

The engine cover of any one of Examples 2-7, wherein first fiber-reinforced polymer material further comprises continuous fibers.

### Example 9

The engine cover of Example 8, wherein the continuous fibers are organic or inorganic fibers.

### Example 10

The engine cover of Example 9, wherein the continuous fibers are at least one of the following: carbon fibers, glass fibers, and aramid fibers.

### Example 11

The engine cover of Examples 2-10, wherein the first fiber-reinforced polymer material comprises a laminate made from at least one of the following: a uni-directional tape, a woven fabric, and a non-woven fabric.

### Example 12

The engine cover of any one of Examples 1-9, wherein the laminate is made through one of the following: a melt process, a chemical solution, a powder, or film impregnation.

### Example 13

The engine cover of Example 2, wherein the second reinforced polymer material further comprises at least one the following: chopped fibers, fillers, and flakes.

### Example 14

The engine cover of Example 13, wherein the chopped fibers are at least one of the following: short-chopped carbon fibers and long-chopped carbon fibers.

### Example 15

The engine cover of any one of Examples 2-13, wherein the first fiber-reinforced polymer material is a continuous carbon fiber-reinforced polyamide and modified polyphenylene ether polymer and the second reinforced polymer material is a short-chopped carbon fiber-reinforced polyamide.

### Example 16

A method of manufacturing of the engine cover of any one of Examples 1-15 comprising: forming a contoured laminate made from a first fiber-reinforced polymer material, forming a plurality of accessory holes in the contoured laminate configured to receive a plurality of engine drive accessories, overmolding or through-molding a reinforcing structure made from a second reinforced polymer material onto at least one portion of the contoured laminate, (preferably wherein the second reinforced polymer material being different from the first fiber-reinforced polymer material), and forming a plurality of attachment holes in the reinforcing structure, the plurality of attachment holes configured to receive a plurality of fasteners.

### Example 17

A method of manufacturing of the engine cover comprising: forming a contoured laminate made from a first fiber-reinforced polymer material, forming a hole in the contoured laminate configured to receive an engine drive accessory, molding (e.g., overmolding or through-molding) a reinforcing structure made from a second reinforced polymer material onto at least one portion of the contoured laminate, and forming an attachment hole in the reinforcing structure, wherein the hole is configured to receive a fastener. Preferably wherein the method is for manufacturing the engine cover of any of Examples 1-15.

Each of these non-limiting examples can stand on its own, or can be combined in various permutations or combinations with one or more of the other examples.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The above detailed description includes references to the accompanying drawings, which form a part of the detailed description. The drawings show, by way of illustration, specific aspects in which the disclosure can be practiced. These aspects are also referred to herein as “examples.” Such examples can include elements in addition to those shown or described. However, the present disclosure also contemplates examples in which only those elements shown or described are provided. Moreover, the present disclosure also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other aspects can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Detailed Description as examples or aspects, with each claim standing on its own as a separate aspect, and it is contemplated that such aspects can be combined with each other in various combinations or permutations. The scope of the disclosure should be determined with reference to the appended claims, along with the full scope of equivalents to which such claims are entitled.

1. An engine cover comprising:
a contoured laminate defining a plurality of accessory holes configured to receive a plurality of accessories;
a corrugated reinforcing structure overlaid on the contoured laminate and connecting with the contoured laminate with at least one smooth transitioning angle between the contoured laminate and the corrugated reinforcing structure, the corrugated reinforcing structure defining a plurality of attachment holes; and
a plurality of fasteners, at least one of the plurality of fasteners being arranged in at least one of the plurality of attachment holes.

2. The engine cover of claim 1, wherein:
the contoured laminate is made from a first fiber-reinforced polymer material, and
the corrugated reinforcing structure is made from a second reinforced polymer material different from the first fiber-reinforced polymer material, the corrugated reinforcing structure being overmolded or through-molded onto a first portion of the contoured laminate.

3. The engine cover of claim 2, wherein the first fiber-reinforced polymer material comprises a first thermoplastic resin.

4. The engine cover of claim 2, wherein the second reinforced polymer material comprises a second thermoplastic resin that is the same or different from the first thermoplastic resin.

5. The engine cover of claim 4, wherein the second thermoplastic resin is polyamide.

6. The engine cover of claim 3, wherein the first thermoplastic resin comprises polyamide and the second thermoplastic resin comprises polyamide.

7. The engine cover of claim 3, wherein the first thermoplastic resin is a combination of polyamide and polyphenylene ether polymer.

8. The engine cover of claim 2, wherein the first fiber-reinforced polymer material further comprises continuous fibers.

9. The engine cover of claim 8, wherein the continuous fibers are organic or inorganic fibers.

10. The engine cover of claim 9, wherein the continuous fibers are at least one of the following: carbon fibers, glass fibers, and aramid fibers.

11. The engine cover of claim 2, wherein the first fiber-reinforced polymer material comprises a laminate made from at least one of the following: a uni-directional tape, a woven fabric, and a non-woven fabric.

12. The engine cover of claim 11, wherein the laminate is made through one of the following: a melt process, a chemical solution, a powder, or film impregnation.

13. The engine cover of claim 2, wherein the second reinforced polymer material further comprises at least one of the following: chopped fibers, fillers, and flakes.

14. The engine cover of claim 13, wherein the chopped fibers are at least one of the following: short-chopped carbon fibers and long-chopped carbon fibers.

15. The engine cover of claim 2, wherein the first fiber-reinforced polymer material is a continuous carbon fiber-reinforced polyamide and modified polyphenylene ether polymer and the second reinforced polymer material is a short-chopped carbon fiber-reinforced polyamide.

16. A method of manufacturing an engine cover, the method comprising:
forming a contoured laminate made from a first fiber-reinforced polymer material;
forming a plurality of accessory holes in the contoured laminate configured to receive a plurality of engine drive accessories;
overmolding or through-molding a reinforcing structure made from a second reinforced polymer material onto at least one portion of the contoured laminate, the second reinforced polymer material being different from the first fiber-reinforced polymer material; and
forming a plurality of attachment holes in the reinforcing structure, the plurality of attachment holes configured to receive a plurality of fasteners.

17. The method of claim 16, wherein the first fiber-reinforced polymer material comprises a first thermoplastic resin and the second reinforced polymer material comprises a second thermoplastic resin different from the first thermoplastic resin.

18. The method of claim 17, wherein the first thermoplastic resin comprises polyamide and the second thermoplastic resin comprises polyamide.

19. The method of claim 17, wherein the first fiber-reinforced polymer material further comprises continuous fibers and the second reinforced polymer material further comprises chopped fibers.

20. The method of claim 16, wherein the first fiber-reinforced polymer material is a continuous carbon fiber-reinforced polyamide and modified polyphenylene ether polymer and the second reinforced polymer material is a short-chopped carbon fiber-reinforced polyamide.
